(19) United States
(12) Patent Application Publication
(10) Pub. No.: US 2005/0114822 A1
(43) Pub. Date: May 26, 2005

(54) Integrated scheme for yield improvement by self-consistent minimization of IC design and process interactions

(76) Inventors: Valery Axelrad, Woodside, CA (US); Andrei Shibkov, San Jose, CA (US); Victor Vladimir Boksha, Los Altos, CA (US)

Correspondence Address: Valery Axelrad, 137 Chapman Rd., Woodside, CA, 94062, US

(21) Appl. No.: 10/790,896

(22) Filed: Mar. 2, 2004

Related U.S. Application Data
(60) Provisional application No. 60/451,428, filed on Mar. 3, 2003.

(51) Int. Cl. G06F 17/50

(52) U.S. Cl. 716/19; 716/2; 716/4

(57) ABSTRACT

A method for performing self-consistent minimization of IC design and process interactions is disclosed. This method is based on calculating the amount of design-process interaction based on the information derived from circuit sensitivity analysis and process characterization. Optical proximity correction is subsequently performed in such a way that a) ensures that desired circuit performance is achieved in a given manufacturing environment if at all possible and b) also limits the increase in mask complexity to a realistic minimum.

### CROSS REFERENCE TO RELATED APPLICATIONS

This patent application is claiming the benefit of a prior filed provisional application Ser. No. 60/451,428, filed on Mar. 03, 2003, entitled “An Integrated Scheme for Yield Improvement by Self-Consistent Minimization of IC Design and Process Interactions”.

### BACKGROUND OF THE INVENTION

1. Field of the Invention

The present invention generally relates to the manufacture of very large scale integrated (VLSI) circuit devices and, more particularly, to the improvement of manufacturability of VLSI circuits through the use of Process Proximity Correction (PPC) and Optical Proximity Correction (OPC).

2. Description of the Related Art

Manufacturing of semiconductor devices is dependent upon the accurate replication of computer aided design (CAD) generated patterns onto the surface of a semiconductor substrate. The replication process is typically performed using optical lithography followed by a variety of subtractive (etch) and additive (deposition) processes. Optical lithography patterning involves the illumination of a metallic coated quartz plate known as a photomask which contains a magnified image of the computer generated pattern etched into the metallic layer. This illuminated image is reduced in size and patterned onto a photosensitive film on the device substrate.

Advanced semiconductor manufacturing is characterized by process proximity effects, which include but are not limited to optical interference (known as optical proximity). Such process proximity effects cause shapes formed on the device substrate to deviate from their ideal dimensions and shape as represented by the original computer design. These deviations depend on the characteristics of the patterns as well as process conditions. Since these deviations significantly impact the performance of integrated circuits, a number of approaches have been pursued which focus on CAD compensation schemes to improve the resultant image.

Performance enhancement of VLSI circuitry is mainly achieved by reducing circuit dimensions resulting in speed improvement. Historically, this has been accomplished by decreasing the illumination wavelength of photolithography equipment. Current advanced technologies are capable of reproducing features smaller than this illumination wavelength at the cost of reduced contrast, pattern fidelity and overall process window width (known as sub-wavelength lithography). As a result, for small dimensions (e.g. sub 0.25 microns), advances are increasingly limited by this lack of pattern fidelity in a series of lithography and etch process steps. In the photolithography process, a pattern is transferred from a photomask to a photosensitive film (resist) on the wafer. In the etch process, this pattern in the resist is transferred into a variety of films on the wafer substrate.

In addition to the costly development of processes with ever-higher effective resolution is the selective process-design correction (PDC) to compensate for pattern distortions occurring during wafer processing (Process Proximity Correction—PPC). A subset of PPC, Optical Proximity Correction (OPC) is commonly used for selective mask biasing. The idea of biasing patterns to compensate for image transfer infidelities has been commonly applied to E-beam lithography to counteract the effects of back scattered electrons. And has also been recently advocated in optical lithography.

All OPC systems increase mask complexity and thus cost of mask manufacturing which becomes a significant fraction of total semiconductor wafer processing cost. This directly translates into increased cost of semiconductor integrated circuits. Apart from increased manufacturing complexity and cost there is one major drawback with the current OPC implementations. This drawback stems from the fact that current OPC implementations use the overall geometric accuracy of the pattern replication of lithography and etch processes as a success criterion (and resulting design rules) for OPC. Such geometry-driven OPC implementations ignore crucial device and circuit sensitivity to pattern distortions. Examples of these, regular rule-based and thus insensitive to circuit performance, OPC implementations can be found in an article by Richard C. Henderson and Oberdan W. Otto, “CD Data Requirements for Proximity Effect Corrections,” 14th Annual BACUS Symposium on Photomask Technology and Management William L. Brodsky and Gilbert V. Shelden, Editors, Proc. SPIE 2322 (1994), pp. 218-228, and in an article by Oberdan W. Otto, Joseph G. Garofalo, K. K Low, Chi-Min Yuan, Richard C. Henderson, Christopher Pierrat, Robert L. Kostelak, Sheila Vaidya, and P. K. Vasudev, “Automated optical proximity correction—a rules-based approach,” Optical/Laser Microlithography VII, Timothy A. Brunner, Editor, Proc. SPIE 2197 (1994), pp. 278-293.

By correcting design portions not relevant to circuit performance, such geometry-driven OPC techniques unnecessarily increase the cost of the OPC process by complicating the CAD data set and mask manufacturing process. Circuit/device behavior is not considered as a criterion for OPC. Therefore the desired performance improvement may not be achieved. Recently attempts have been made to address these inefficiencies. It has been proposed to selectively correct only those mask features, which are likely to affect device performance. This has been accomplished by identifying and applying correction only to minimum sized layout features as proposed in U.S. Pat. No. 6,189,136 or identifying layout features which correspond to active devices and only correcting those, as proposed in U.S. Pat. No. 5,740,068. These techniques, although more advanced, still can not guarantee that desired circuit performance is achieved in silicon while producing masks which are potentially significantly more complex and expensive than needed. These factors reduce effectiveness of previously proposed techniques and limit their practical applications.

From the above it is clear that an effective PDC method should have circuit performance as its main criterion. This is the core of our invention described below.

### SUMMARY OF THE INVENTION

The present invention fills these needs by providing methods for improving the performance and yield of semiconductor ICs by achieving an effective reduction of interaction between design of an integrated circuit and process used for its manufacturing.

The method of the present invention for performing optical proximity correction limits the correction effort to only those structures correction of which is required to achieve desired circuit performance with the specific manufacturing process and in the specific manufacturing environment. The method of the present invention also self-consistently calculates the required amount of correction and maximum size of the correction unit (edge fragment) based on the circuit design characteristics and process specifics thus improving the accuracy of the corrections and minimizing added mask complexity.

The method includes the steps of:
1 inputting the chip design including layout and circuit netlist
2 performing circuit sensitivity analysis to determine acceptable range of circuit element characteristics
3 performing process characterization by means of either using test structures or TCAD simulations to determine device sensitivities to device geometry distortions in the given manufacturing process
4 calculating acceptable device geometry tolerances and maximum correction unit (edge fragment) size based on the results of steps 2 and 3
5 identifying devices on the layout
6 further identifying electrically relevant edge sections and subdividing those into segments
7 performing a simulation of the lithographic process
8 calculating the amount of distortions of relevant edge sections based on the results of step 7
9 comparing the calculated amount of distortion to device geometry tolerances determined in step 4
10 applying the correction in the amount required to achieve desired tolerances
11 repeating steps 7 through 10 until correction is no longer required or predetermined number of iterations is exceeded.

### BRIEF DESCRIPTION OF THE DRAWINGS

FIG. 1 is a flow chart of a method of the invention.

FIG. 2 Layout example showing MOSFETs as combinations of polysilicon and diffusion design database layers.

FIG. 3 Transistors identified as intersection of polysilicon and diffusion layers.

FIG. 4 Slicing methodology to capture three-dimensional transistor geometry effects by a 2.5 dimensional multi-transistor subcircuit.

FIG. 5 Aerial image simulation of the electrically relevant polysilicon layer (gate) before OPC.

FIG. 6 Aerial image simulation of the electrically relevant polysilicon layer (gate) after OPC (corrected mask also shown).

### DETAILED DESCRIPTION OF THE PREFERRED EMBODIMENT OF THE INVENTION

The present invention includes an integrated simulation scheme for yield improvement by self-consistent minimization of design and process interactions. Circuit sensitivity to device performance and device performance sensitivity to geometry distortions is analyzed using process-specific device models, thus capturing design-process interactions. Devices are then identified on layout and geometry distortion is predicted using lithographic process simulation. Layout corrections are subsequently applied only where it is required to meet circuit performance requirements.

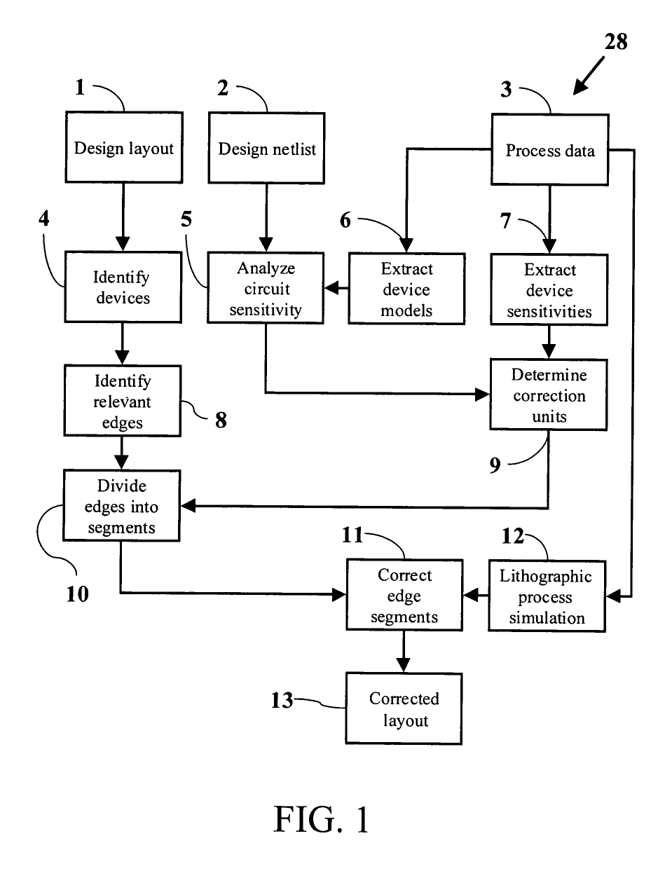

FIG. 1 is a flow chart 28 of a method of the present invention. In this method, the design data comprising design layout 1 and design netlist 2 is used in combination with process data 3 to calculate corrections required to improve design yield.

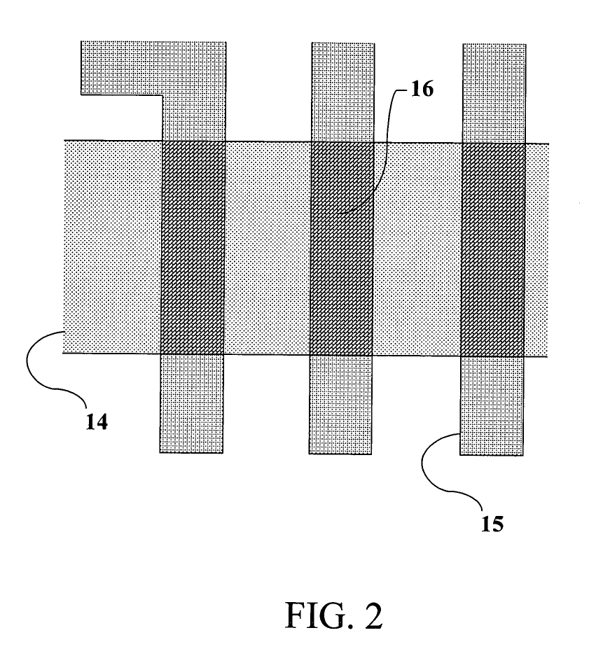

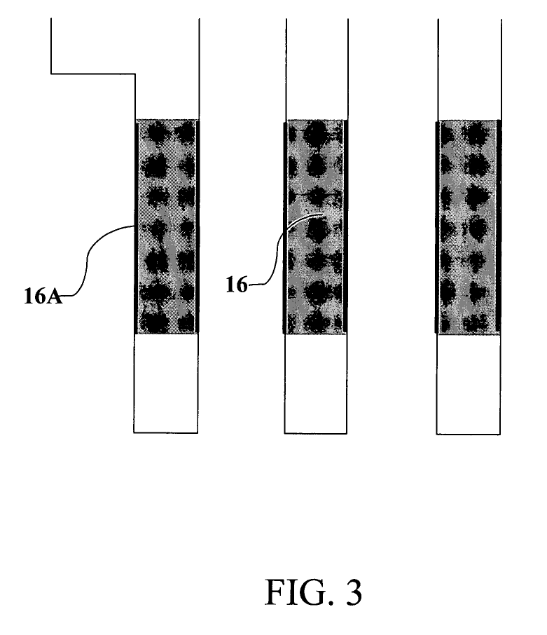

Device identification step 4 is illustrated in FIG. 2 and FIG. 3, active devices 16 are identified by performing boolean AND on poly 15 and active 14 layer masks. Electrically relevant edges 16A are then identified in step 8 using design-specific rules. In FIG. 3 electrically relevant edges are those edges of the rectangular device gate which define gate length. In other cases electrically relevant may be considered other edges of poly gates as well as active layer edges which determine device width.

Process data 3 comprises of all information required for accurate lithography process simulation and either electrical measurement data required for process-specific SPICE device model extraction 6 and extraction of device sensitivities 7.

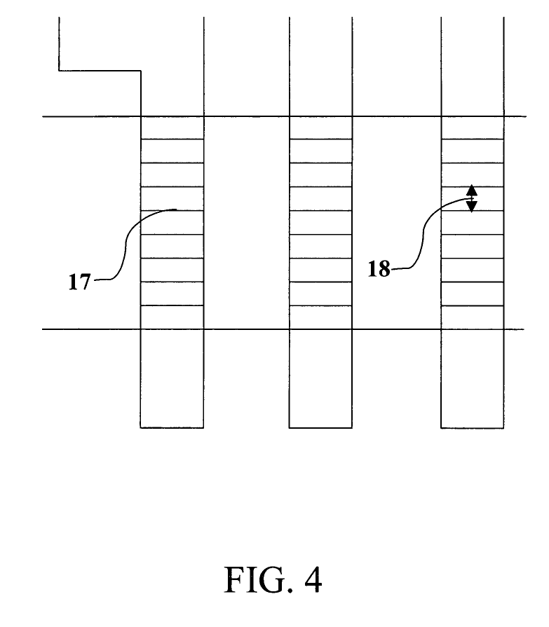

Extracted device models 6 are used to analyze circuit sensitivity 5 using SPICE circuit simulations. Circuit sensitivities to individual characteristics of each device are used in combination with device sensitivities 7 to calculate correction units 9. Correction unit is defined as minimum measurement step along electrically relevant edges 1 6A required for characterizing each device performance with acceptable degree of accuracy. After relevant edges identification 8 is complete and correction units 9 are calculated, electrically relevant edges 16A are divided into segments as indicated by 10 in the flowchart. The meaning of measurement unit is illustrated in FIG. 4 where measurement locations “cutlines” 17 are spaced by the amount 18 equal to calculated measurement unit.

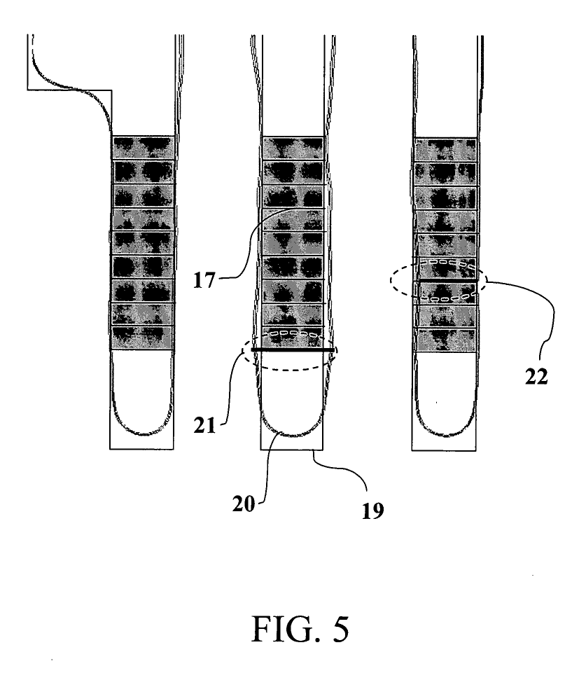

Lithographic process simulation 12 is then performed. Lithography simulation produces outlines 20 of electrically relevant mask elements 19 as shown in FIG. 5. Electrically relevant device geometry is measured at the locations of cutlines 17. Locations of excessive geometry distortions are identified as illustrated in FIG. 5 where 21 is location where lithography distortion results in polysilicon segment being too wide and 22 is the location where lithography distortion results in polysilicon segment being too narrow.

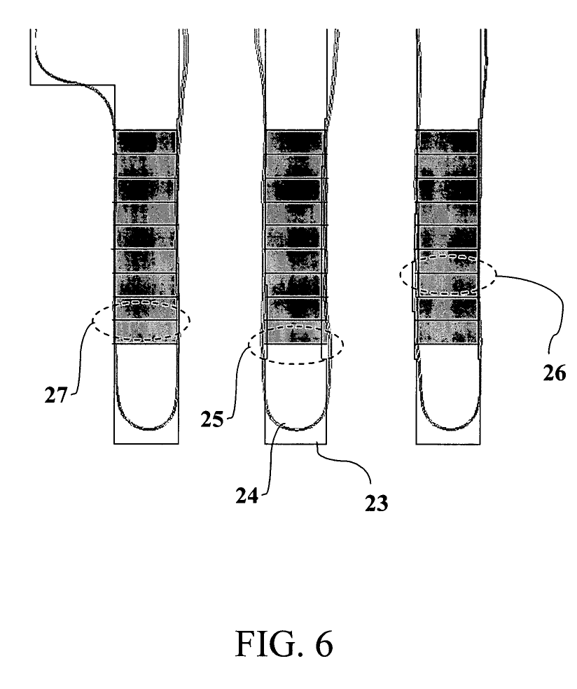

Mask corrections 11 are subsequently performed to compensate for lithography distortions. As shown in FIG. 6. Mask 23 is corrected at each measurement location to compensate for lithography distortions. Amount of correction is based on 9. Correction is performed only where it is needed to maintain required circuit performance. As illustrated in FIG. 6, mask is undersized at location 25, oversized at location 26 and not changed at location 27. These corrections bring device geometry into required range of tolerances as shown by layer contour 24 simulated with corrected mask.

Steps 11 through 13 can be repeated several times if further corrections are required. This iterative process is terminated when either a maximum number of iterations (steps) is reached, or desired degree of fidelity is achieved.

Utility of the Invention

The IC industry is expected to double in size and to approach $300 billion by the year 2010. However, it is also obvious that the industry is rapidly consolidating and that growth will be significantly slower—it is entering the mode of economies of scale. Expectations of continuing annual 15% growth with 25-30% of transistor/function cost reduction are not justified anymore. These processes are especially visible in Japan—in the same manner as Japanese government built semiconductor business in 70s, it aggressively and decisively scales it down now.

Therefore, IC manufacturing now is a rapidly maturing industry with corresponding commoditization of products. This conclusion is heavily based on lithography related considerations, issues of complexity & competitive/marketing situation. It means that cost (e.g. optimization of the integrated design-manufacturing flows) and productivity (e.g. yield) are the main industry drivers now. Therefore, integration throughout full design flows based on the modularity concept and new standards is the only way to maintain reasonable profits.

Our invention is related to the field of complex process-design interactions, which are increasingly responsible for an increase of electrical device variability and a dramatic reduction of available process windows in modern IC manufacturing. This field is manifested by the phenomena of the “merging” of the $50 billion semiconductor equipment market with the $4 billion electronic design automation (EDA) market through the intermediate silicon infrastructure sector, which is estimated to be $2.5 billion by 2004.

Large electrical device variability is caused by unacceptably wide gate critical dimension (CD) distributions due to process proximity effects. Wide CD distributions lead to narrow and biased process windows for electrical performance parameters such as ioff, Vth, Idsat, etc.

Our invention allows enlarging and centering electrical performance windows resulting in improved manufacturability, yield and product performance.

Semiconductor manufacturing yield improvement means higher productivity for the industry. In addition, our invention re-defines the design to manufacturing interface through a unified design-to-process flow. This improvement is directly related to a significant cost reduction for the industry.

1. A method for yield improvement of VLSI integrated circuits by self-consistent minimization of process and design interactions, said method comprising the steps of:
a) inputting a design data set that define a pre-selected chip design including layout data and circuit design data which define electrical functionality of said IC design
b) performing circuit sensitivity analysis to determine acceptable range of circuit element characteristics based on the predefined nominal circuit performance specifications
c) performing IC manufacturing process characterization to extract nominal device models and quantify device sensitivities to geometry distortions
d) using data gathered in step b) and c) to determine maximum layout correction unit and acceptable range of geometry distortion for all devices
e) identifying devices on the layout
f) further identifying electrically relevant edge sections and subdividing those into segments on which subsequent correction is to be performed. Segment size is calculated in step d)
g) performing simulation of lithographic process using known optical and etch parameters
h) applying corrections to edge segments selected in step f) applying the correction only where it is needed and only in the amount based on the acceptable range of geometry distortion determined in step d) for all devices
i) incorporating said corrections into final corrected photomask features

2. The method of yield improvement of VLSI integrated circuits according to claim 1 in which TCAD simulations are used for extracting nominal device models in step c) of claim 1

3. The method of yield improvement of VLSI integrated circuits according to claim 1 in which TCAD simulations are used for calculating device sensitivities to geometry distortions in step c) of claim 1

4. The method of yield improvement of VLSI integrated circuits according to claim 1 in which TCAD simulations are used exclusively for both extracting nominal device models and calculating device sensitivities to geometry distortions in step c) of claim 1

5. The method of yield improvement of VLSI integrated circuits according to claim 1 further comprising the below steps to be performed after step h) and before step i) of claim 1:
a) simulation of lithographic process as in step g) of claim 1
b) quantifying geometric distortions of the segments identified in step f) of claim 1

6. The method of yield improvement of VLSI integrated circuits according to claim 1 further comprising steps outlined below to be performed after step h) and before step i) of claim 1:
c) simulating of lithographic process as in step g) of claim 1
d) quantifying geometric distortions of the segments identified in step f) of claim 1
e) applying corrections as in step h) of claim 1.

7. The method of yield improvement of VLSI integrated circuits according to claim 6 in which steps c) through e) are repeated in the loop until either geometry distortions of all correction segments meet the minimum requirements determined in step d) of claim 1 or preset number of iterations is exceeded.
